(19) United States
(12) Patent Application Publication
(10) Pub. No.: US 2026/0025710 A1
(43) Pub. Date: Jan. 22, 2026

(54) FIRST ACCESS POINT, COMMUNICATION SYSTEM AND METHOD

(71) Applicant: NEC Platforms, Ltd., Kanagawa (JP)

(72) Inventors: Tomohiro HARADA, Kanagawa (JP); Shigeki Muramatsu, Kanagawa (JP); Akifumi Wakasugi, Kanagawa (JP); Hirotoshi Yano, Kanagawa (JP)

(73) Assignee: NEC Platforms, Ltd., Kanagawa (JP)

(21) Appl. No.: 19/262,544

(22) Filed: Jul. 8, 2025

(30) Foreign Application Priority Data
Jul. 22, 2024 (JP) 2024-116926

(51) Int. Cl. H04W 28/086; H04W 60/04; H04W 76/16

(52) U.S. Cl. CPC H04W 28/0861; H04W 60/04; H04W 76/16

(57) ABSTRACT

An object of the present disclosure is to provide a first access point, a communication system, a method, and a program that enable a wireless terminal to seamlessly roam to an access point in a communication system including a plurality of access points and the wireless terminal. A first access point according to the present disclosure includes a first transmission unit that transmits, to a second access point among a plurality of wireless links, key information that is necessary for using a first wireless link among the plurality of wireless links and can be used in common in a second wireless link, and association information of a wireless terminal, and a second transmission unit that transmits, to the wireless terminal, identification information for connecting to the second access point using the second wireless link.

### INCORPORATION BY REFERENCE

This application is based upon and claims the benefit of priority from Japanese patent application No. 2024-116926, filed on Jul. 22, 2024, the disclosure of which is incorporated herein in its entirety by reference.

### TECHNICAL FIELD

The present disclosure relates to a first access point, a communication system, a method, and a program, and more particularly, to a first access point, a communication system, a method, and a program that enable a wireless terminal to seamlessly roam to an access point in a communication system including a plurality of access points and the wireless terminal.

### BACKGROUND ART

A communication system in which a plurality of access points cooperate to communicate with a wireless terminal is known. In such a communication system, if a wireless terminal roams to an access point, disconnection for switching occurs once. Therefore, in the communication system, seamless roaming in which disconnection does not occur is desired.

JP 2024-36463 A discloses “According to an example embodiment, a wireless communication device includes: a processing unit that generates a first frame based on data and management information relevant to the data; and a wireless unit that transmits the first frame to a first communication device.

The processing unit checks whether a notification including management information indicating that transmission of the first frame is successful is received from a second communication device different from the first communication device, transmits the first frame to the first communication device via the wireless unit in a case where the notification is not received, transmits the notification including the management information to the second communication device in a case where a response frame to the first frame from the first communication device is normally received, and discards the first frame in a case where the notification is received”. JP 2024-36463 A does not disclose “the wireless terminal seamlessly roams to the access point”.

### SUMMARY

As described above, in the communication system, seamless roaming in which disconnection does not occur is desired.

In order to solve the above-described problem, an example object of the present disclosure is to provide a first access point, a communication system, a method, and a program that enable a wireless terminal to seamlessly roam to an access point in a communication system including a plurality of access points and the wireless terminal.

A first access point according to a first example aspect of the present disclosure includes:
a first transmission unit that transmits, to a second access point of a plurality of wireless links, key information that is necessary to use a first wireless link among the plurality of wireless links and can be used in common by a second wireless link, and association information of a wireless terminal;
a second transmission unit that transmits, to the wireless terminal, identification information for connecting with the second access point by using the second wireless link,
in which a first communication load amount of the wireless terminal with respect to the first access point is controlled based on a comparison between the first communication load amount and a second communication load amount of the wireless terminal with respect to the second access point.

A communication system according to a second example aspect of the present disclosure includes:
a first access point;
a wireless terminal that establishes connection with the first access point and communicates with the first access point; and
a second access point, in which
the first access point includes:
a first transmission unit that transmits, to the second access point, key information that is necessary to use a first wireless link among the plurality of wireless links and can be used in common by a second wireless link, and association information of the wireless terminal; and
a second transmission unit that transmits, to the wireless terminal, identification information for connecting to the second access point using the second wireless link of the plurality of wireless links,
the wireless terminal includes:
a first communication unit that establishes connection and communicates with the first access point using the first wireless link; and
a second communication unit that establishes connection and communicates with the first access point via the second access point using the second wireless link based on the identification information of the second access point and the key information,
the second access point includes:
a second access point communication unit that establishes connection and communicates with the wireless terminal using the second wireless link based on the association information of the wireless terminal and the key information, and
a first communication load amount of the wireless terminal with respect to the first access point is controlled based on a comparison between the first communication load amount and a second communication load amount of the wireless terminal with respect to the second access point.

A communication system according to a third example aspect of the present disclosure includes:
a first access point;
a wireless terminal that establishes connection with the first access point and communicates with the first access point; and
a second access point, in which
the first access point includes:
a first transmission unit that transmits, to the second access point, key information that is necessary to use a first wireless link among the plurality of wireless links and can be used in common by a second wireless link, and association information of the wireless terminal; and
a second transmission unit that transmits, to the wireless terminal, identification information for connecting to the second access point using the second wireless link of the plurality of wireless links,
the wireless terminal includes:
a first communication unit that establishes connection and communicates with the first access point using the first wireless link; and
a second communication unit that establishes connection and communicates with the first access point via the second access point using the second wireless link based on the identification information of the second access point and the key information,
the second access point includes:
a second access point communication unit that establishes connection and communicates with the wireless terminal using the second wireless link based on the association information of the wireless terminal and the key information, and
a first communication load amount of the wireless terminal with respect to the first access point is controlled based on a comparison between a first distance from the first access point to the wireless terminal and a second distance from the second access point to the wireless terminal.

A method according to a fourth example aspect of the present disclosure includes:
transmitting, to a second access point of a plurality of wireless links, key information that is necessary to use a first wireless link among the plurality of wireless links and can be used in common by a second wireless link, and association information of a wireless terminal;
transmitting, to the wireless terminal, identification information for connecting with the second access point by using the second wireless link; and
controlling a first communication load amount of the wireless terminal with respect to a first access point based on a comparison between the first communication load amount and a second communication load amount of the wireless terminal with respect to the second access point.

A program according to a fifth example aspect of the present disclosure causes a computer to execute:
transmitting, to a second access point of a plurality of wireless links, key information that is necessary to use a first wireless link among the plurality of wireless links and can be used in common by a second wireless link, and association information of a wireless terminal;
transmitting, to the wireless terminal, identification information for connecting with the second access point by using the second wireless link; and
controlling a first communication load amount of the wireless terminal with respect to a first access point based on a comparison between the first communication load amount and a second communication load amount of the wireless terminal with respect to the second access point.

According to the present disclosure, it is possible to provide a first access point, a communication system, a method, and a program that enable a wireless terminal to seamlessly roam to an access point in a communication system including a plurality of access points and the wireless terminal.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a communication system according to the present disclosure;

FIG. 2 is a block diagram illustrating an effect of the communication system according to the present disclosure;

FIG. 3 is a sequence diagram illustrating an operation of the communication system according to the present disclosure;

FIG. 4 is a flowchart illustrating an operation of the first access point according to the present disclosure;

FIG. 5 is a diagram illustrating an Association Response frame format according to the present disclosure; and

FIG. 6 is a block diagram illustrating a hardware configuration of the communication system according to the present disclosure.

### EXAMPLE EMBODIMENT

Hereinafter, example embodiments of the present disclosure will be described with reference to the drawings. In the drawings, the same or corresponding elements are denoted by the same reference signs and redundant description will be omitted if necessary for clarity of description.

### EXAMPLE EMBODIMENT

### Overview

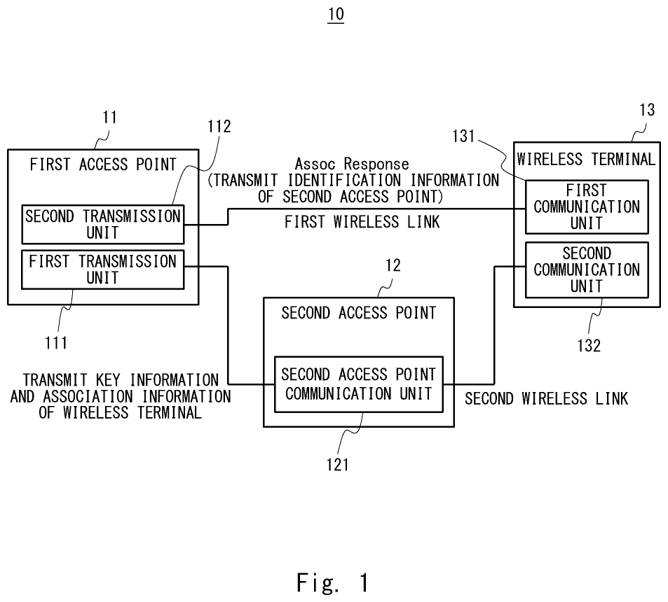

FIG. 1 is a block diagram illustrating a communication system according to the present disclosure.

As illustrated in FIG. 1, a communication system 10 according to the present disclosure includes a first access point 11, a wireless terminal 13 that establishes connection with and communicates with the first access point 11, and a second access point 12.

The first access point 11 includes a first transmission unit 111 and a second transmission unit 112. The first transmission unit 111 transmits, to the second access point 12, key information that is necessary for using a first wireless link among the plurality of wireless links and can be commonly used in a second wireless link, and association information of the wireless terminal 13. The second transmission unit 112 transmits, to the wireless terminal 13, identification information for connecting to the second access point 12 using the second wireless link among the plurality of wireless links.

The wireless terminal 13 includes a first communication unit 131 and a second communication unit 132. The first communication unit 131 establishes connection and communicates with the first access point 11 using the first wireless link among the plurality of wireless links. The identification information of the second access point 12 is transmitted from the first access point 11 to the wireless terminal 13 using the first wireless link. Based on the identification information of the second access point 12, the second communication unit 132 establishes connection and communicates with the first access point 11 via the second access point 12 using the second wireless link among the plurality of wireless links.

The first wireless link is, for example, a wireless link in a 5 GHz (gigahertz) band, and the second wireless link is, for example, a wireless link in a 2.4 GHz band.

The second access point 12 includes a second access point communication unit 121. The second access point communication unit 121 establishes connection and communicates with the wireless terminal 13 using the second wireless link based on the association information and the key information of the wireless terminal 13.

The communication system 10 controls a first communication load amount of the wireless terminal 13 with respect to the first access point 11 based on a comparison between the first communication load amount and a second communication load amount of the wireless terminal 13 with respect to the second access point 12.

### <Control of Communication Load Amount—Example of Wireless Environment>

For example, in a case where the wireless environment of the first wireless link between the first access point 11 and the wireless terminal 13 is better than the wireless environment of the second wireless link between the second access point 12 and the wireless terminal 13, the communication system 10 performs control so that the amount of data allocated to the first wireless link is larger than the amount of data allocated to the second wireless link.

The wireless environment of the first wireless link may be a bit error rate transmitted from the first access point 11 and received by the wireless terminal 13, and the wireless environment of the second wireless link may be a bit error rate transmitted from the second access point 12 and received by the wireless terminal 13. A throughput amount calculated based on the wireless environment may be used as an index of control.

For example, in a case where the wireless environment of the first wireless link is equivalent to the wireless environment of the second wireless link, the communication system 10 performs control so that the amount of data allocated to the first wireless link and the amount of data allocated to the second wireless link are the same.

For example, in a case where the wireless environment of the first wireless link is worse than the wireless environment of the second wireless link, the communication system 10 performs control so that the amount of data allocated to the first wireless link is smaller than the amount of data allocated to the second wireless link.

### <Control of Communication Load Amount—Example of Allowable Communication Amount>

For example, in a case where the allowable communication amount of the first wireless link is larger than the allowable communication amount of the second wireless link, the communication system 10 performs control so that the amount of data allocated to the first wireless link is larger than the amount of data allocated to the second wireless link.

For example, in a case where the allowable communication amount of the first wireless link is equal to the allowable communication amount of the second wireless link, the communication system 10 performs control so that the amount of data allocated to the first wireless link and the amount of data allocated to the second wireless link are the same.

For example, in a case where the allowable communication amount of the first wireless link is smaller than the allowable communication amount of the second wireless link, the communication system 10 performs control so that the amount of data allocated to the first wireless link is smaller than the amount of data allocated to the second wireless link.

The communication system 10 may have a multi-link operation (MLO) function, and may control the first communication load amount by automatically optimizing the load distribution ratio between the wireless links using a function of optimizing the load distribution ratio of the multi-link operation.

The MLO is a technology of integrating a plurality of bands into one band and performing communication. For example, the MLO is a function of creating a first wireless link of 5 GHz and a second wireless link of 2.4 GHz between an access point and a wireless terminal, and integrating these wireless links into one to perform communication.

The wireless terminal may also be referred to as a mobile terminal or a station (STA: Station). The access point may also be referred to as an AP.

### <Effects>

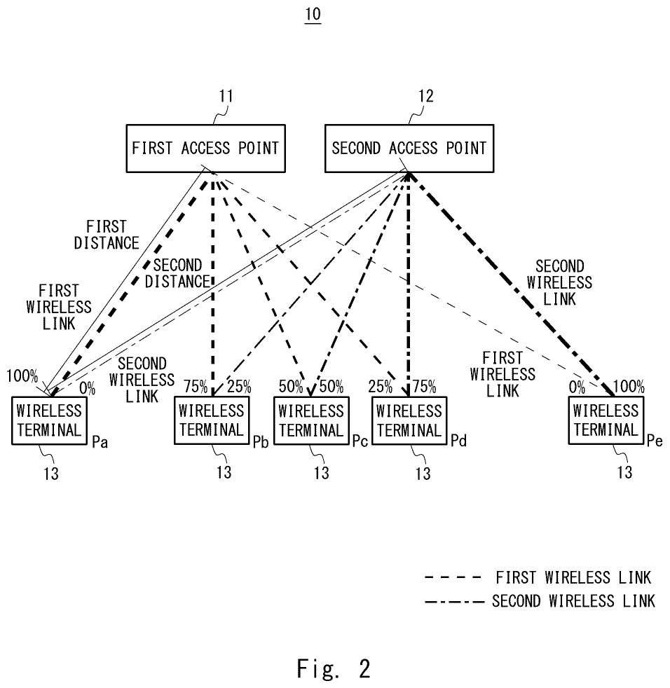

FIG. 2 is a block diagram illustrating an effect of the communication system according to the present disclosure.

FIG. 2 illustrates an example of a case where the first communication load amount of the wireless terminal 13 with respect to the first access point 11 is controlled based on a comparison between a first distance from the first access point 11 to the wireless terminal 13 and a second distance from the second access point 12 to the wireless terminal 13.

The communication system 10 may control the first communication load amount of the wireless terminal 13 with respect to the first access point 11 based on a comparison between the first distance from the first access point 11 to the wireless terminal 13 and the second distance from the second access point 12 to the wireless terminal 13.

First, a case where the wireless terminal 13 is present at the position Pa will be described.

In this case, the second access point 12 is too far from the wireless terminal 13 (the distance is too large), and the radio wave from the second access point 12 does not reach the wireless terminal 13. Thus, 100% (percent) of the data is transmitted and received between the first access point 11 and the wireless terminal 13 using the first wireless link. No data is transmitted or received using the second wireless link.

Next, a case where the wireless terminal 13 is present at the position Pb will be described.

In this case, the distance from the first access point 11 to the wireless terminal 13 is shorter than the distance from the second access point 12 to the wireless terminal 13. The intensity of the radio wave from the first access point 11 is higher than the intensity of the radio wave from the second access point 12. Thus, 75% of the data is transmitted and received between the first access point 11 and the wireless terminal 13 using the first wireless link. 25% of the data is transmitted and received between the second access point 12 and the wireless terminal 13 using the second wireless link.

Next, a case where the wireless terminal 13 is present at the position Pc will be described.

In this case, the distance from the first access point 11 to the wireless terminal 13 is the same as the distance from the second access point 12 to the wireless terminal 13. The intensity of the radio wave from the first access point 11 is the same as the intensity of the radio wave from the second access point 12. Thus, 50% of the data is transmitted and received between the first access point 11 and the wireless terminal 13 using the first wireless link. 50% of the data is transmitted and received between the second access point 12 and the wireless terminal 13 using the second wireless link.

Next, a case where the wireless terminal 13 is present at the position Pd will be described.

In this case, the distance from the first access point 11 to the wireless terminal 13 is longer than the distance from the second access point 12 to the wireless terminal 13. The intensity of the radio wave from the first access point 11 is smaller than the intensity of the radio wave from the second access point 12. Thus, 25% of the data is transmitted and received between the first access point 11 and the wireless terminal 13 using the first wireless link. 75% of the data is transmitted and received between the second access point 12 and the wireless terminal 13 using the second wireless link.

Finally, a case where the wireless terminal 13 is present at the position Pe will be described.

In this case, the first access point 11 is too far from the wireless terminal 13 (the distance is too large), and the radio wave from the first access point 11 does not reach the wireless terminal 13. Thus, 100% of the data is transmitted and received between the second access point 12 and the wireless terminal 13 using the second wireless link. No data is transmitted or received using the first wireless link.

In a case where the wireless terminal 13 moves and its position changes, for example, to the position Pa, the position Pb, the position Pc, the position Pd, and the position Pe, a multi-link operation (MLO) function may be used to perform control so that the communication load (amount of data to be allocated) for the wireless link is optimized. The MLO control changes the load distribution ratios of the first access point 11 and the second access point 12 in stages, and either one of the first access point 11 and the second access point 12 can always communicate with each other. Therefore, in the example embodiment, there is no moment at which communication is disabled. That is, there is no instantaneous interruption time from “disconnecting from the original access point” to “connecting to the next access point”. As a result, seamless roaming becomes possible.

As a result, according to the example embodiment, it is possible to provide the first access point, the communication system, the method, and the program that enable the wireless terminal 13 to seamlessly roam to the access point.

In this example, the distance between the access point (the first access point 11 or the second access point 12) and the wireless terminal 13 is used as the index of the “load distribution ratio”, but the present invention is not limited thereto. As an index of the load distribution ratio, radio wave intensity, a communication speed, or the like may be used.

### <Sequence Operation of Communication System>

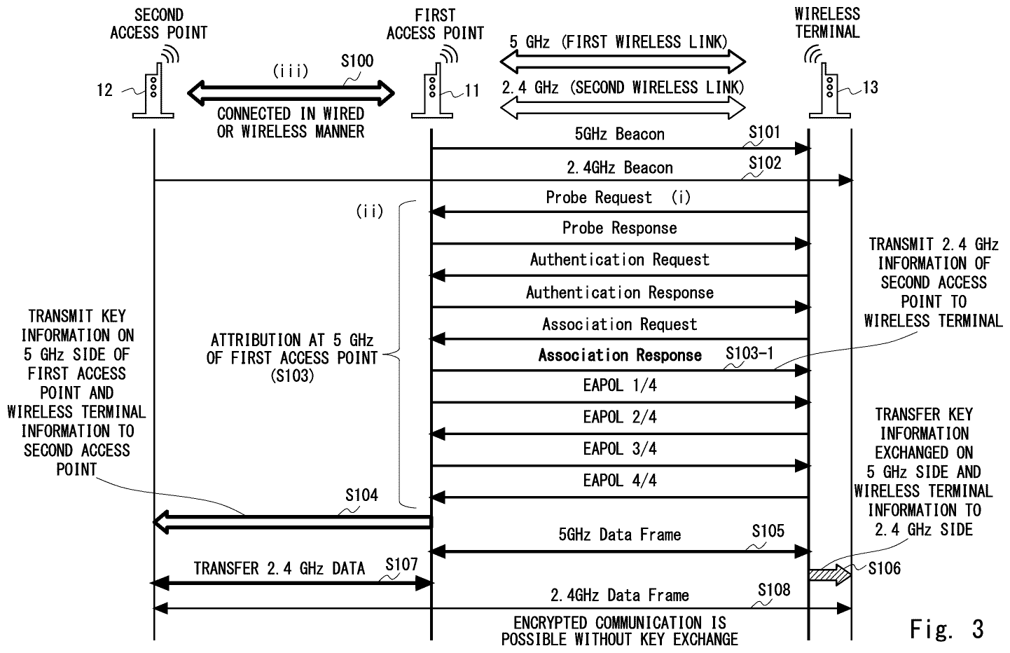

FIG. 3 is a sequence diagram illustrating an operation of a communication system according to the present disclosure.

FIG. 3 illustrates a MLO link establishment sequence of a communication system according to the present disclosure.

In this example, a “wireless link in a 5 GHz band” will be described as an example of the first wireless link, and a “wireless link in a 2.4 GHz band” will be described as an example of the second wireless link, but the present invention is not limited thereto.

As illustrated in (iii) of FIG. 3, it is assumed that the first access point 11 and the second access point 12 have been connected in advance in a wired or wireless manner (step S100).

As illustrated in FIG. 3, a beacon of 5 GHz is transmitted from the first access point 11 to the wireless terminal 13 (step S101).

The beacon of 2.4 GHz is transmitted from the second access point 12 to the wireless terminal 13 (step S102).

As illustrated in (i) and (ii) of FIG. 3, for example, a link establishment sequence is performed at 5 GHz of the first access point 11 (step S103).

In the link establishment sequence in step S103, identification information (for example, a media access control (MAC) address) of a radio frequency band interface (for example, a 2.4 GHz interface) of the second access point 12 is transmitted to the wireless terminal 13 (step S103-1). In step S103-1, the MAC address of the 2.4 GHz interface may be transmitted from the first access point 11 to the wireless terminal 13 using an association response of the MLO.

The key information and the association information of the wireless terminal 13 are transmitted from the first access point 11 to the second access point 12 (step S104). The key information is necessary for using the first wireless link on the 5 GHz side of the first access point 11 and can be commonly used in the second wireless link. The association information of the wireless terminal 13 is, for example, MAC address information of the wireless terminal 13.

By step S103, after the link establishment sequence is completed at 5 GHz of the first access point 11, a 5 GHz data frame is configured between the first access point 11 and the wireless terminal 13, and data can be transmitted and received (step S105).

In the wireless terminal 13, the key information exchanged on the 5 GHz side (5 GHz interface) and the identification information of the wireless terminal 13 are transferred to the 2.4 GHz side (2.4 GHz interface) (step S106).

Data for 2.4 GHz is transferred from the first access point 11 to the second access point 12 (step S107).

In step S106, after the key information exchanged on the 5 GHz side and the identification information of the wireless terminal 13 are transferred to the 2.4 GHz side, a 2.4 GHz data frame is formed between the first access point 11 and the wireless terminal 13, and data can be transmitted and received (step S108).

Upon completion of step S108, encrypted communication can be performed without key exchange between second access point 12 and wireless terminal 13 using the 2.4 GHz interface (second wireless link).

### <Operation of First Access Point>

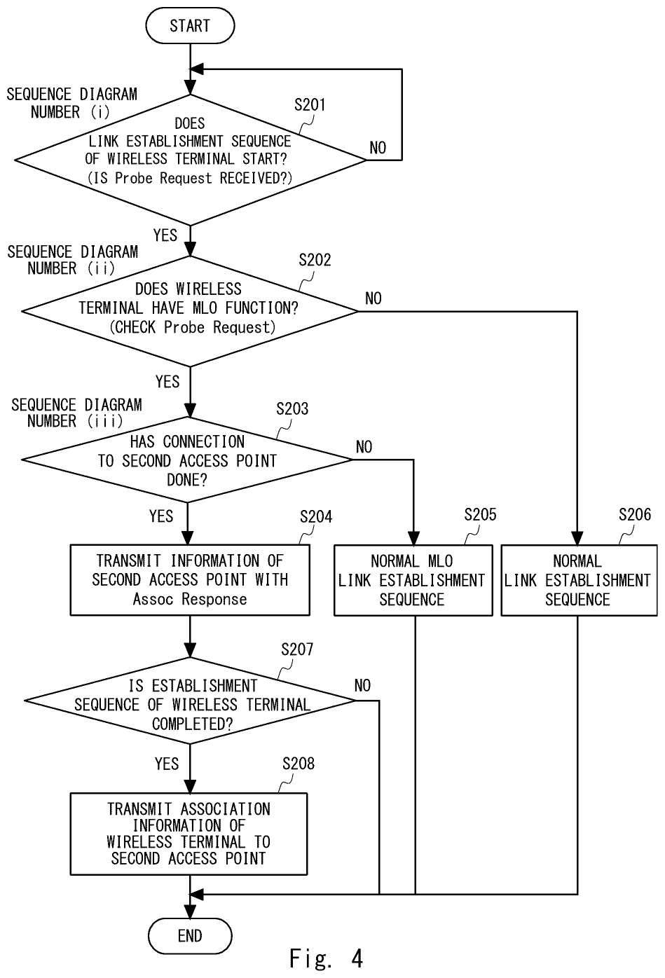

FIG. 4 is a flowchart illustrating an operation of the first access point according to the present disclosure.

In FIG. 4, for convenience of description, the operation of the sequence diagram number (iii) is performed after the operations of the sequence diagram numbers (i) and (ii). In FIG. 3, the operation of the sequence diagram number (iii) is performed before the operations of the sequence diagram numbers (i) and (ii).

The first access point 11 checks whether a Probe Request is received from the wireless terminal 13 (step S201). The first access point 11 starts a link establishment sequence of the wireless terminal 13 by receiving the Probe Request (step S201: Yes). In a case where the Probe Request is not received from the wireless terminal 13 (step S201: No), the first access point 11 repeats step S201. Step S201 is relevant to the Probe Request of the sequence diagram number (i) illustrated in FIG. 3.

In a case where the Probe Request has been received from the wireless terminal 13 (step S201: Yes), the first access point 11 checks whether the wireless terminal 13 has an MLO function (step S202). In a case where the wireless terminal 13 has no MLO function (step S202: No), the first access point 11 executes a normal link establishment sequence (step S206).

In a case where the wireless terminal 13 has the MLO function (step S202: Yes), the first access point 11 checks whether it is already connected to the second access point 12 (step S203). In a case where connection to the second access point 12 is not yet done (step S203: No), the first access point 11 executes a normal MLO link establishment sequence (step S205).

In a case where the first access point 11 is already connected to the second access point 12 (Step S203: Yes), the first access point 11 transmits identification information of a 2.4 GHz interface of the second access point 12 to the wireless terminal 13 with a MLO association response (Step S204). Step S204 is relevant to step S103-1 illustrated in FIG. 3.

After step S204, the first access point 11 checks whether the link establishment sequence of the wireless terminal 13 is completed (step S207).

In a case where the link establishment sequence of the wireless terminal 13 is completed (step S207: Yes), the first access point 11 transmits association information of the wireless terminal 13 to the second access point 12 (step S208). Step S208 is relevant to step S104 illustrated in FIG. 3.

### <Association Response>

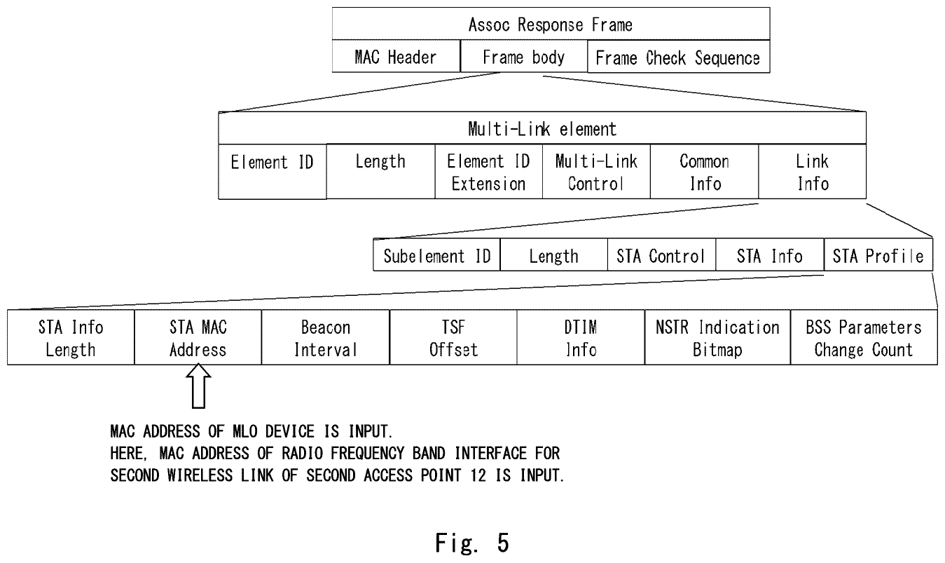

FIG. 5 is a diagram illustrating an Association Response frame format according to the present disclosure.

Here, the operation of step S103-1 illustrated in FIG. 3, that is, the details of Association Response will be described.

As illustrated in FIG. 5, according to the Association Response frame format, the “Association Response Frame” includes a “Frame body”, and the “Frame body” includes a “Multi-Link element”. The “Multi-Link element” includes “Link Info”, the “Link Info” includes “STA Profile”, and the “STA Profile” includes “STA MAC Address”.

In the example embodiment, “STA MAC Address” in “Assoc Response frame” is used. Specifically, this operation in which the first access point 11 adds the MAC address of the MLO device (the radio frequency band interface for the second wireless link of the second access point 12) to “STA MAC Address” in the “Assoc Response frame” and transmits the resulting frame to the wireless terminal 13 is relevant to step S103-1 illustrated in FIG. 3. As a result, the first access point 11 transmits, to the wireless terminal 13, MAC address information of a radio frequency band interface for the second wireless link of the second access point 12 as MLO connection destination information.

In the example embodiment, the first access point 11 transmits the MAC address of the MLO device (the radio frequency band interface for the second wireless link) of the second access point 12 to the wireless terminal 13 with the “STA MAC address” in the “Association Response” (step S103-1 in FIG. 3). The MLO device of the first access point 11 (the radio frequency band interface for the first wireless link) is attributed in step S103. Through these operations, the MLO device of the first access point 11 (the radio frequency band interface for the first wireless link) and the MLO device of the second access point 12 (the radio frequency band interface for the second wireless link) are recognized as MLO connection destinations.

That is, the wireless terminal 13 recognizes the MLO devices of the two access points as the MLO connection destinations. The MLO device required to establish the wireless link is the radio frequency band interface of the access point.

### <Features>

The multi-link operation (MLO) is a technology for integrating a plurality of radio frequency bands into one and performing communication. For example, a first wireless link (5 GHz wireless link) and a second wireless link (2.4 GHz wireless link) are created between an access point and a wireless terminal, and these wireless links are integrated into one for communication.

In the example embodiment, by replacing the roaming destination of the second wireless link with the second access point, it is possible to roam while the wireless terminal sees one access point. Specifically, using Association Response of a link establishment sequence, a MAC address of the second access point different from the first access point is transmitted to the wireless terminal (slave device) as an MLO interface. This enables MLO between the first access point and the wireless terminal and between the second access point and the wireless terminal. This enables seamless roaming.

On the other hand, in a comparative example in which the example embodiment is not used, the access point uses Association Response to transmit the MAC address of the unused frequency band interface of the same access point to the wireless terminal as the MLO interface. As a result, in the comparative example, since communication can be performed with only one access point, it is difficult to perform seamless roaming.

### <Hardware Configuration>

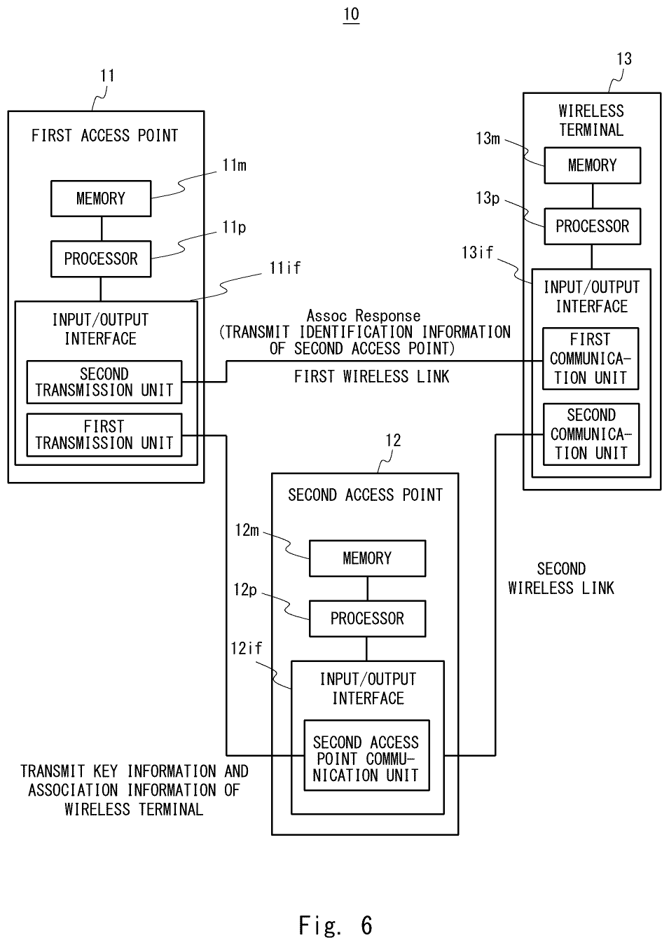

FIG. 6 is a block diagram illustrating a hardware configuration of the communication system according to the present disclosure.

As illustrated in FIG. 6, the wireless terminal 13 includes a processor 13p, a memory 13m, and an input/output interface 13if. The input/output interface 13if includes a first communication unit 131 and a second communication unit 132. An instruction related to the wireless terminal 13 is stored in the memory 13m, and the processor 13p executes the instruction related to the wireless terminal 13. The instruction related to the wireless terminal 13 includes an instruction to control the input/output interface 13if.

The first access point 11 includes a processor 11p, a memory 11m, and an input/output interface 11if. The input/output interface 11if includes a first transmission unit 111 and a second transmission unit 112. An instruction related to the first access point 11 is stored in the memory 11m, and the processor 11p executes the instruction related to the first access point 11. The instruction related to the first access point 11 includes an instruction for controlling the input/output interface 11if.

The second access point 12 includes a processor 12p, a memory 12m, and an input/output interface 12if. The input/output interface 12if includes a second access point communication unit 121. An instruction related to the second access point 12 is stored in the memory 12m, and the processor 12p executes the instruction related to the second access point 12. The instruction related to the second access point 12 includes an instruction for controlling the input/output interface 12if.

In the above example embodiment, two wireless links (the first wireless link and the second wireless link) have been described by way of example, but the present invention is not limited thereto. The example embodiment can be implemented by, for example, three or more wireless links such as 6 GHz in addition to 2.4 GHz and 5 GHz.

In the above-described example embodiments, the present disclosure has been described as a hardware configuration, but the present disclosure is not limited thereto. The present disclosure can also implement processing of each component by causing a central processing unit (CPU) to execute a computer program.

In addition, in the above-described example embodiment, the program can be stored using various types of non-transitory computer-readable media and supplied to the computer. The non-transitory computer-readable media include various types of tangible storage media. Examples of the non-transitory computer-readable media include a magnetic recording medium (specifically, a flexible disk, a magnetic tape, or a hard disk drive), a magneto-optical recording medium (specifically, a magneto-optical disk), a CD-read only memory (ROM), a CD-R, a CD-R/W, and a semiconductor memory (specifically, a mask ROM, a programmable ROM (PROM), an erasable PROM (EPROM), a flash ROM, or a random access memory (RAM). The program may be supplied to the computer by various types of transitory computer-readable media. Examples of transitory computer readable media include electrical signals, optical signals, and electromagnetic waves. The transitory computer readable media can supply the programs to the computer via a wired communication path such as an electric wire and an optical fiber or a wireless communication path.

Moreover, while operations are illustrated in a specific order, this should not be understood as requiring that such operations be performed in the specific order illustrated or in a sequential order, or that all operations illustrated be executed, to achieve desirable results. In a specific situation, multitasking and parallel processing may be advantageous. Similarly, while details of some specific example embodiments are included in the above discussion, these should be construed as descriptions of features specific to the specific example embodiments, rather than as limitations on the scope of the present disclosure. Specific features described in the context of separate example embodiments may be implemented in combination in a single example embodiment. Conversely, various features described in the context of a single example embodiment may be implemented in a plurality of example embodiments separately or in any suitable combination.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

Each of the drawings is merely an example to illustrate one or more example embodiments. Each of the drawings is not associated with only one specific example embodiment, but may be associated with one or more other example embodiments. As those ordinary skilled in the art will appreciate, various features or steps described with reference to any one of the drawings may be combined with features or steps illustrated in one or more other drawings, for example, to create an example embodiment that is not explicitly illustrated or described. All of the features or steps illustrated in any one of the figures for describing illustrative example embodiments are not necessarily mandatory, and some features or steps may be omitted. The order of the steps described in any of the figures may be changed as appropriate.

Note that the present disclosure is not limited to the above-described example embodiments, and can be appropriately changed without departing from the gist.

Some or all of the above-described example embodiments may be described as the following Supplementary Notes, but are not limited to the following Supplementary Notes.

### (Supplementary Note 1)

A first access point including:
a first transmission unit that transmits, to a second access point of a plurality of wireless links, key information that is necessary to use a first wireless link among the plurality of wireless links and can be used in common by a second wireless link, and association information of a wireless terminal;
a second transmission unit that transmits, to the wireless terminal, identification information for connecting with the second access point by using the second wireless link,
in which a first communication load amount of the wireless terminal with respect to a first access point is controlled based on a comparison between the first communication load amount and a second communication load amount of the wireless terminal with respect to the second access point.

### (Supplementary Note 2)

The first access point according to Supplementary Note 1, in which
the second access point has a radio frequency band interface for the second wireless link,
the identification information of the second access point is media access control (MAC) address information of the radio frequency band interface of the second access point, and
the association information of the wireless terminal is MAC address information of the wireless terminal.

### (Supplementary Note 3)

The first access point according to Supplementary Note 1, in which
the first wireless link is a wireless link in a 5 GHz (gigahertz) band, and
the second wireless link is a wireless link in a 2.4 GHz band.

### (Supplementary Note 4)

The first access point according to Supplementary Note 2, in which the identification information of the radio frequency band interface of the second access point is transmitted from the first access point to the wireless terminal using an association response of a multi-link operation (MLO).

### (Supplementary Note 5)

The first access point according to Supplementary Note 1, in which the first access point has a multi-link operation (MLO) function, and controls the first communication load amount using a function of optimizing a load distribution ratio of the multi-link operation.

### (Supplementary Note 6)

The first access point according to Supplementary Note 1, in which in a case where a wireless environment of the first wireless link between the first access point and the wireless terminal is better than a wireless environment of the second wireless link between the second access point and the wireless terminal, the first access point performs control in such a way that an amount of data allocated to the first wireless link is larger than an amount of data allocated to the second wireless link.

### (Supplementary Note 7)

The first access point according to Supplementary Note 6, in which
a wireless environment of the first wireless link is a bit error rate transmitted from the first access point and received by the wireless terminal, and
a wireless environment of the second wireless link is a bit error rate transmitted from the second access point and received by the wireless terminal.

### (Supplementary Note 8)

A communication system including:
a first access point;
a wireless terminal that establishes connection with the first access point and communicates with the first access point; and
a second access point, in which
the first access point includes:
a first transmission unit that transmits, to the second access point, key information that is necessary to use a first wireless link among the plurality of wireless links and can be used in common by a second wireless link, and association information of the wireless terminal; and
a second transmission unit that transmits, to the wireless terminal, identification information for connecting to the second access point using the second wireless link of the plurality of wireless links,
the wireless terminal includes:
a first communication unit that establishes connection and communicates with the first access point using the first wireless link; and
a second communication unit that establishes connection and communicates with the first access point via the second access point using the second wireless link based on the identification information of the second access point and the key information,
the second access point includes:
a second access point communication unit that establishes connection and communicates with the wireless terminal using the second wireless link based on the association information of the wireless terminal and the key information, and
a first communication load amount of the wireless terminal with respect to the first access point is controlled based on a comparison between the first communication load amount and a second communication load amount of the wireless terminal with respect to the second access point.

### (Supplementary Note 9)

A communication system including:
a first access point;
a wireless terminal that establishes connection with the first access point and communicates with the first access point; and
a second access point, in which
the first access point includes:
a first transmission unit that transmits, to the second access point, key information that is necessary to use a first wireless link among the plurality of wireless links and can be used in common by a second wireless link, and association information of the wireless terminal; and
a second transmission unit that transmits, to the wireless terminal, identification information for connecting to the second access point using the second wireless link of the plurality of wireless links,
the wireless terminal includes:
a first communication unit that establishes connection and communicates with the first access point using the first wireless link; and
a second communication unit that establishes connection and communicates with the first access point via the second access point using the second wireless link based on the identification information of the second access point and the key information,
the second access point includes:
a second access point communication unit that establishes connection and communicates with the wireless terminal using the second wireless link based on the association information of the wireless terminal and the key information, and
a first communication load amount of the wireless terminal with respect to the first access point is controlled based on a comparison between a first distance from the first access point to the wireless terminal and a second distance from the second access point to the wireless terminal.

### (Supplementary Note 10)

The communication system according to Supplementary Note 8 or 9, in which
the second access point has a radio frequency band interface for the second wireless link,
the identification information of the second access point is media access control (MAC) address information of the radio frequency band interface of the second access point, and
the association information of the wireless terminal is MAC address information of the wireless terminal.

### (Supplementary Note 11)

A method including:
transmitting, to a second access point of a plurality of wireless links, key information that is necessary to use a first wireless link among the plurality of wireless links and can be used in common by a second wireless link, and association information of a wireless terminal;
transmitting, to the wireless terminal, identification information for connecting with the second access point by using the second wireless link; and
controlling a first communication load amount of the wireless terminal with respect to a first access point based on a comparison between the first communication load amount and a second communication load amount of the wireless terminal with respect to the second access point.

### (Supplementary Note 12)

A program causing a computer to execute:
transmitting, to a second access point of a plurality of wireless links, key information that is necessary to use a first wireless link among the plurality of wireless links and can be used in common by a second wireless link, and association information of a wireless terminal;
transmitting, to the wireless terminal, identification information for connecting with the second access point by using the second wireless link; and
controlling a first communication load amount of the wireless terminal with respect to a first access point based on a comparison between the first communication load amount and a second communication load amount of the wireless terminal with respect to the second access point.

What is claimed is:

1. A first access point comprising:
at least one memory; and
at least one processor coupled to the memory,
wherein the at least one processor is configured to execute:
transmitting, to a second access point of a plurality of wireless links, key information that is necessary to use a first wireless link among the plurality of wireless links and can be used in common by a second wireless link, and association information of a wireless terminal;
transmitting, to the wireless terminal, identification information for connecting with the second access point using the second wireless link; and
controlling a first communication load amount of the wireless terminal with respect to a first access point based on a comparison between the first communication load amount and a second communication load amount of the wireless terminal with respect to the second access point.

2. The first access point according to claim 1, wherein
the second access point has a radio frequency band interface for the second wireless link,
the identification information of the second access point is media access control (MAC) address information of the radio frequency band interface of the second access point, and
the association information of the wireless terminal is MAC address information of the wireless terminal.

3. The first access point according to claim 1, wherein
the first wireless link is a wireless link in a 5 GHz (gigahertz) band, and
the second wireless link is a wireless link in a 2.4 GHz band.

4. The first access point according to claim 2, wherein the identification information of the radio frequency band interface of the second access point is transmitted from the first access point to the wireless terminal using an association response of a multi-link operation (MLO).

5. The first access point according to claim 1, wherein the first access point has a multi-link operation (MLO) function, and controls the first communication load amount using a function of optimizing a load distribution ratio of the multi-link operation.

6. The first access point according to claim 1, wherein in a case where a wireless environment of the first wireless link between the first access point and the wireless terminal is better than a wireless environment of the second wireless link between the second access point and the wireless terminal, the first access point performs control in such a way that an amount of data allocated to the first wireless link is larger than an amount of data allocated to the second wireless link.

7. The first access point according to claim 6, wherein
a wireless environment of the first wireless link is a bit error rate transmitted from the first access point and received by the wireless terminal, and
a wireless environment of the second wireless link is a bit error rate transmitted from the second access point and received by the wireless terminal.

8. A communication system comprising:
a first access point;
a wireless terminal that establishes connection with the first access point and communicates with the first access point; and
a second access point, wherein
the first access point includes:
at least one memory for a first access point; and
at least one processor for a first access point coupled to a memory for the first access point,
the at least one processor for a first access point is configured to execute:
transmitting, to the second access point, key information that is necessary to use a first wireless link among a plurality of wireless links and can be used in common by a second wireless link, and association information of the wireless terminal; and
transmitting, to the wireless terminal, identification information for connecting to the second access point using the second wireless link of the plurality of wireless links,
the wireless terminal includes:
at least one terminal memory; and
at least one terminal processor coupled to the terminal memory,
the at least one terminal processor is configured to execute:
establishing connection and communicating with the first access point using the first wireless link; and
establishing connection and communicating with the first access point via the second access point using the second wireless link based on the identification information of the second access point and the key information,
the second access point includes:
at least one memory for a second access point; and
at least one processor for a second access point coupled to the memory for the second access point, and
the at least one processor for the second access point is configured to execute:
establishing connection and communicating with the wireless terminal using the second wireless link based on the association information of the wireless terminal and the key information, and
controlling a first communication load amount of the wireless terminal with respect to the first access point based on a comparison between the first communication load amount and a second communication load amount of the wireless terminal with respect to the second access point.

9. The communication system according to claim 8, wherein
the second access point has a radio frequency band interface for the second wireless link,
the identification information of the second access point is media access control (MAC) address information of the radio frequency band interface of the second access point, and
the association information of the wireless terminal is MAC address information of the wireless terminal.

10. A method comprising:
transmitting, to a second access point of a plurality of wireless links, key information that is necessary to use a first wireless link among the plurality of wireless links and can be used in common by a second wireless link, and association information of a wireless terminal;
transmitting, to the wireless terminal, identification information for connecting with the second access point by using the second wireless link; and
controlling a first communication load amount of the wireless terminal with respect to a first access point based on a comparison between the first communication load amount and a second communication load amount of the wireless terminal with respect to the second access point.
